(19) United States
(12) Patent Application Publication
(10) Pub. No.: US 2022/0156057 A1
(43) Pub. Date: May 19, 2022

(54) IN-VEHICLE UPDATE DEVICE, UPDATE PROCESSING PROGRAM, AND PROGRAM UPDATE METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Takuya Kobayashi, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 17/439,156

(22) PCT Filed: Mar. 18, 2020
(86) PCT No.: PCT/JP2020/011929

§ 371 Date: Sep. 14, 2021

(30) Foreign Application Priority Data
Mar. 18, 2019 (JP) 2019-050057

(51) Int. Cl. G06F 8/65; B60W 50/06

(52) U.S. Cl. CPC G06F 8/65; B60W 2556/45; B60W 50/06

(57) ABSTRACT

An in-vehicle update device acquires an update program transmitted from an external server located outside a vehicle, and updates a program for an in-vehicle control device. The in-vehicle update device includes a storage unit and a control unit, and the storage unit is configured to store the update program, and the control unit is configured to control transmission of the update program to an update target in-vehicle control device. When acquiring the update program from the external server, the control unit transmits saved data stored in the storage unit to the external server, or to a non-update target in-vehicle control device other than the update target in-vehicle control device, based on the data type of the saved data. The control unit stores at least part of the update program acquired from the external server in an area of the storage unit in which the transmitted saved data was stored.

### CROSS-REFERENCE TO RELATED APPLICATIONS

This application is the U.S. national stage of PCT/JP2020/011929 filed on Mar. 18, 2020, which claims priority of Japanese Patent Application No. JP 2019-050057 filed on Mar. 18, 2019, the contents of which are incorporated herein.

### TECHNICAL FIELD

The present disclosure relates to an in-vehicle update device, an update processing program, and a program update method.

### BACKGROUND

Vehicles are provided with in-vehicle ECUs (Electronic Control Units) for controlling in-vehicle devices such as a power train system for controlling an engine and so on, and a body system for controlling an air conditioner and so on. The in-vehicle ECUs include computation processing units such as MPUs, rewriteable nonvolatile storage units such as RAMs, and communication units for communicating with other in-vehicle ECUs, and control in-vehicle devices by reading and executing programs stored in the storage units. Furthermore, relay devices that have wireless communication functionality are mounted in the vehicles. It is possible to communicate with a program providing device that is connected to a network outside the vehicle, via the relay device, download (receive) a program for an in-vehicle ECU from the program providing device, and update a program for the in-vehicle ECU (for example, see JP 2017-97851A). The relay device disclosed in JP 2017-97851A stores the program for the in-vehicle ECU received from the program providing device in a storage unit of the relay device.

When a program for an in-vehicle control device (in-vehicle ECU) is to be updated, if, for example, a plurality of programs are acquired or the file size of a single program is increased, the total data volume of the programs acquired from a program providing device will increase, and thus there is concern that the total data volume will exceed the storage capacity of a storage unit of a relay device.

An object of the present disclosure is to provide an in-vehicle update device that can prevent a shortage in the storage capacity of a storage unit of the in-vehicle update device that may occur when updating a program for an in-vehicle control device.

### SUMMARY

According to an aspect of the present disclosure, an in-vehicle update device for acquiring an update program transmitted from an external server located outside a vehicle, and performing processing for updating a program for an in-vehicle control device mounted in the vehicle includes: a storage unit; and a control unit, wherein the storage unit is configured to store the update program. The control unit is configured to control transmission of the update program to an update target in-vehicle control device, when acquiring the update program from the external server, the control unit transmits saved data stored in the storage unit to the external server, or to a non-update target in-vehicle control device other than the update target in-vehicle control device, based on a data type of the saved data, and the control unit stores at least part of the update program acquired from the external server, in an area of the storage unit in which the transmitted saved data was stored.

### ADVANTAGEOUS EFFECTS OF PRESENT DISCLOSURE

According to an aspect of the present disclosure, an in-vehicle update device is provided that can prevent a shortage in the storage capacity of a storage unit of the in-vehicle update device that may occur when updating a program for an in-vehicle control device.

### BRIEF DESCRIPTION OF DRAWINGS

FIG. 1 is a schematic diagram illustrating an example of a configuration of an in-vehicle update system according to a first embodiment.

FIG. 2 is a block diagram illustrating examples of configurations of an in-vehicle update device and so on.

FIG. 3 is a diagram illustrating an example of an aspect of saved data stored in a storage unit.

FIG. 4 is a diagram (sequence diagram) illustrating an example of an aspect of an update that is performed by the in-vehicle update device.

FIG. 5 is a flowchart illustrating an example of processing that is performed by a control unit of the in-vehicle update device.

FIG. 6 is a flowchart illustrating an example of processing that is performed by a control unit of an in-vehicle update device according to a second embodiment.

### DETAILED DESCRIPTION OF PREFERRED EMBODIMENTS

First, embodiments of the present disclosure will be listed and described. At least one or more of the embodiments described below may be combined together in any manner.

According to an aspect of the present disclosure, an in-vehicle update device for acquiring an update program transmitted from an external server located outside a vehicle, and performing processing for updating a program for an in-vehicle control device mounted in the vehicle includes: a storage unit; and a control unit, wherein the storage unit is configured to store the update program. The control unit is configured to control transmission of the update program to an update target in-vehicle control device, when acquiring the update program from the external server, the control unit transmits saved data stored in the storage unit to the external server, or to a non-update target in-vehicle control device other than the update target in-vehicle control device, based on a data type of the saved data, and the control unit stores at least part of the update program acquired from the external server, in an area of the storage unit in which the transmitted saved data was stored.

With this aspect, when acquiring the update program from the external server, the control unit transmits saved data stored in the storage unit to the external server, or to a non-update target in-vehicle control device other than the update target in-vehicle control device, based on a data type of the saved data, and stores at least part of the update program in an area of the storage unit in which the transmitted saved data was stored. That is to say, when acquiring the update program from the external server, even if the free space of the storage unit of the in-vehicle update device is less than the total data volume of the update program, the control unit can store the entire update program in the storage unit by storing at least part of the update program in the area of the storage unit in which the transmitted saved data was stored. When part of the update program is stored in the area in which the transmitted saved data was stored, the remaining portion of the update program is stored in the free area of the storage unit that was there before the saved data was transmitted. Alternatively, the entire update program may be stored in the area in which the transmitted saved data was stored. Therefore, it is possible to prevent a shortage in the storage capacity of the storage unit of the in-vehicle update device by using the area in which the saved data was stored as an area for storing the update program, and store the saved data at an appropriate destination (saving destination) based on the data type of the saved data.

The in-vehicle update device according to an aspect of the present disclosure is such that the saved data to be transmitted to the external server has a lower degree of importance for the in-vehicle update device or the vehicle than a degree of importance of the saved data to be transmitted to the non-update target in-vehicle control device.

With this aspect, the saved data to be transmitted to the external server has a lower degree of importance for the in-vehicle update device than the degree of importance of the saved data to be transmitted to the non-update target in-vehicle control device, and thus saved data having a high degree of importance is transmitted to the non-update target in-vehicle control device. Accordingly, because the non-update target in-vehicle control device is mounted in the vehicle, the relay device can acquire the saved data transmitted to and saved in the non-update target in-vehicle control device from this non-update target in-vehicle control device, even if, for example, communication with the external server is difficult.

The in-vehicle update device according to an aspect of the present disclosure is such that the pieces of saved data are each stored in the storage unit with a data type and a degree of importance associated with each other.

With this aspect, since the pieces of saved data are each stored in the storage unit with a data type and a degree of importance associated with each other, the control unit can efficiently derive the destination of saved data based on the data type of the saved data.

The in-vehicle update device according to an aspect of the present disclosure is such that the control unit acquires a total data volume of the update program from the external server before acquiring the update program, and if a sum of free space of the storage unit and a total data volume of the saved data to be transmitted to the external server is less than the total data volume of the update program, the control unit transmits the saved data other than the saved data to be transmitted to the external server, to the non-update target in-vehicle control device.

With this aspect, if the sum of the current free space of the storage unit and the total data volume of the saved data to be transmitted to the external server is less than the total data volume of the update program, the control unit transmits the saved data other than the saved data to be transmitted to the external server, to the non-update target in-vehicle control device, and thus it is possible to suppress an increase in the communication volume of the communication path between the relay device and the in-vehicle control device.

The in-vehicle update device according to an aspect of the present disclosure is such that the control unit acquires a total data volume of the update program from the external server before acquiring the update program, and if a sum of free space of the storage unit, a total data volume of the saved data to be transmitted to the external server, and a total data volume of the saved data to be transmitted to the non-update target in-vehicle control device is greater than the total data volume of the update program, the control unit transmits the respective pieces of saved data to the external server and the non-update target in-vehicle control device, based on the data types of the respective pieces of saved data.

With this aspect, if the sum of the free space of the storage unit, the total data volume of the saved data to be transmitted to the external server, and the total data volume of the saved data to be transmitted to the non-update target in-vehicle control device is greater than or equal to the total data volume of the update program, the control unit transmits the respective pieces of saved data to the external server and the non-update target in-vehicle control device. Accordingly, only when the area of the storage unit for storing an update program can be secured by transmitting saved data, the control unit transmits the saved data and acquires the update program, and thus it is possible to reliably store the acquired update program.

The in-vehicle update device according to an aspect of the present disclosure is such that, while acquiring the update program from the external server, the control unit transmits the saved data to the external server, and if free space of the storage unit is reduced to a value less than or equal to a predetermined value while the update program is being acquired, the control unit transmits the saved data other than the saved data to be transmitted to the external server, to the non-update target in-vehicle control device.

With this aspect, while acquiring the update program from the external server, the control unit transmits the saved data to the external server, and thus there is no need to perform a preparatory operation for acquiring the update program, making it possible to reduce the time required for a series of processing for updating the update target in-vehicle control device.

The in-vehicle update device according to an aspect of the present disclosure is such that the vehicle includes a plurality of the in-vehicle control devices, the in-vehicle update device includes a plurality of vehicle interior communication units for communicating with the plurality of in-vehicle control devices, and the control unit transmits the saved data to the non-update target in-vehicle control devices respectively connected to the different vehicle interior communication units, in parallel.

With this aspect, the in-vehicle update device includes a plurality of vehicle interior communication units, and the control unit transmits the saved data to the non-update target in-vehicle control devices respectively connected to the different vehicle interior communication units, in parallel. Accordingly, the control unit can use the communication volume (bandwidth) obtained by summing up the permissible communication volumes (bandwidths) of the vehicle interior communication units to transmit the saved data to the non-update target in-vehicle control devices, making it possible to reduce the time required for the transmission.

An update processing program according to an aspect of the present disclosure is for causing a computer to execute processing of; transmitting saved data stored in a storage unit to an external server, or to a non-update target in-vehicle control device other than an update target in-vehicle control device mounted in a vehicle, based on a data type of the saved data; storing an update program acquired from the external server, in an area of the storage unit in which the transmitted saved data was stored; and transmitting the stored update program to the update target in-vehicle control device.

With this aspect, it is possible to cause a computer to function as an in-vehicle update device that can prevent a shortage in the storage capacity of a storage unit of the in-vehicle update device that may occur when updating a program for an in-vehicle control device.

A program update method according to an aspect of the present disclosure includes the steps of; transmitting saved data stored in a storage unit to an external server, or to a non-update target in-vehicle control device other than an update target in-vehicle control device mounted in a vehicle, based on a data type of the saved data; storing an update program acquired from the external server, in an area of the storage unit in which the transmitted saved data was stored; and transmitting the stored update program to the update target in-vehicle control device.

With this aspect, it is possible to provide a program update method that can prevent a shortage in the storage capacity of a storage unit of the in-vehicle update device that may occur when updating a program for an in-vehicle control device.

The following specifically describes the present disclosure based on drawings that illustrate embodiments thereof. An in-vehicle update device 2 according to the embodiments of the present disclosure will be described below with reference to the drawings. Note that the present disclosure is not limited to the examples, but is indicated by the claims, and is intended to include all modifications within the meaning and scope equivalent to the scope of the claims.

### First embodiment

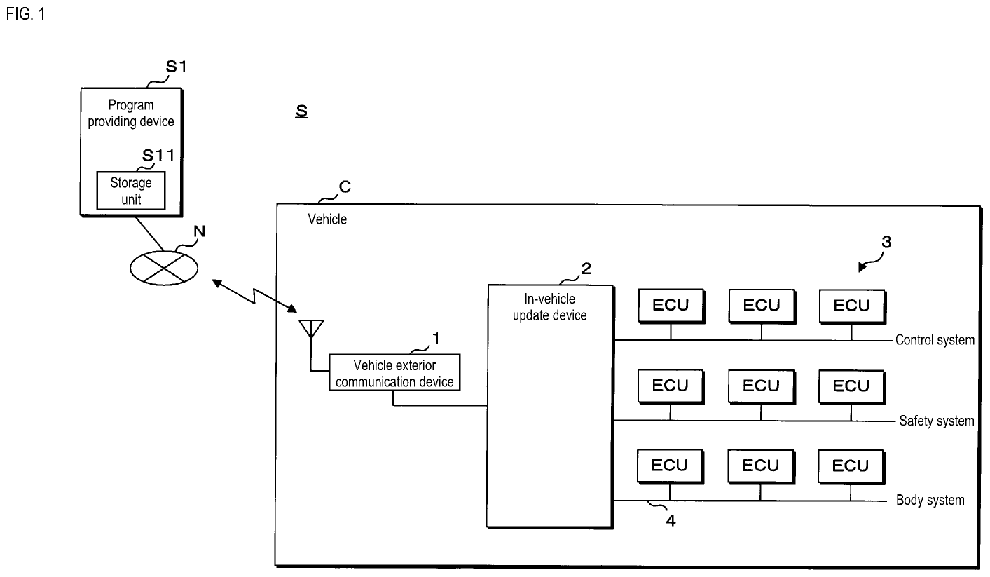

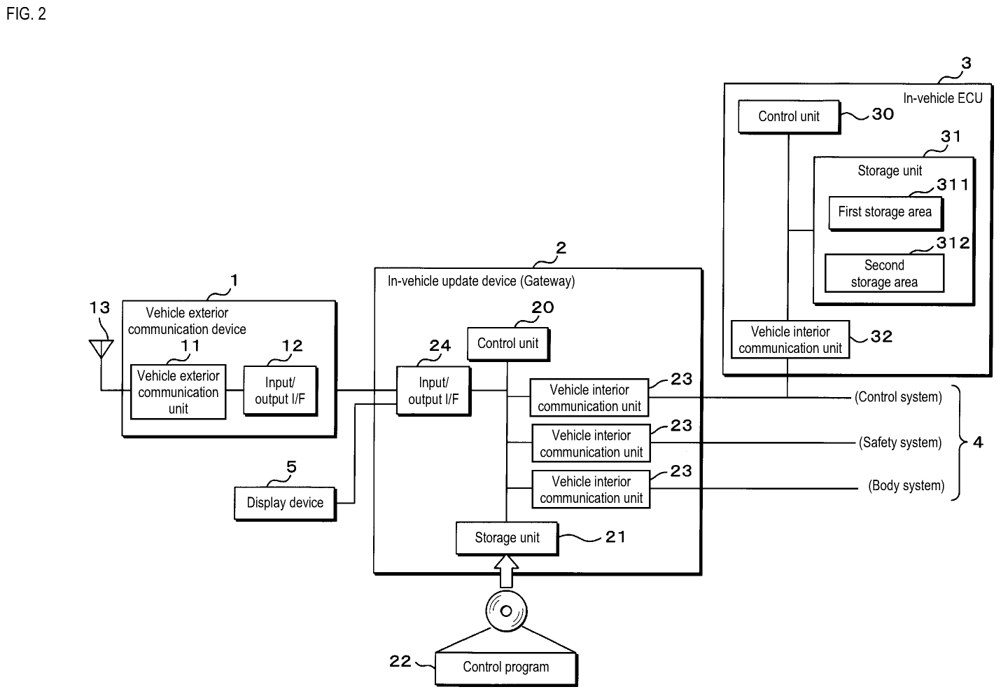

The following describes an embodiment based on the drawings. FIG. 1 is a schematic diagram showing an example of a configuration of an in-vehicle update system according to a first embodiment. FIG. 2 is a block diagram showing examples of configurations of an in-vehicle update device and so on. An in-vehicle update system S includes a vehicle exterior communication device 1 and an in-vehicle update device 2 that are provided in a vehicle C, and transmits a program or data acquired from an external server S1 that is connected to the in-vehicle update system S via a vehicle exterior network N, to an in-vehicle ECU 3 (Electronic Control Unit/in-vehicle control device) provided in the vehicle C.

Communication between the external server S1 and the in-vehicle update device 2 is performed via the vehicle exterior communication device 1, and the bandwidth (communication speed/throughput) between the external server S1 and the in-vehicle update device 2 via the vehicle exterior communication device 1 is greater than the bandwidth (communication speed/throughput) between the in-vehicle update device 2 and the in-vehicle ECU 3. Accordingly, in order to absorb the difference between these bandwidths, the in-vehicle update device 2 temporarily stores (caches) a program and so on (update program) acquired from the external server S1 in a storage unit 21 of the in-vehicle update device 2. After having temporarily stored a portion or the entirety of data of the program (update program) in the storage unit 21, the in-vehicle update device 2 transmits the program and so on (update program) to the in-vehicle ECU 3.

The external server S1 is a computer such as a server connected to the vehicle exterior network N such as, for example, the Internet or a public network, and includes a storage unit S11 realized by a RAM (Random Access Memory), a ROM (Read Only Memory), a hard disk, or the like. The external server S1 corresponds to a program providing device located outside the vehicle. A program or data for controlling an in-vehicle ECU 3, created by the manufacturer or the like of the in-vehicle ECU 3, is stored in the storage unit S11 of the external server S1. Saved data transmitted from the in-vehicle update device 2 is stored in the storage unit S11 of the external server S1, which will be described in detail later. This program or data is transmitted as an update program to the vehicle C as will be described later, and is used to update a program or data for an in-vehicle ECU 3 provided in the vehicle C. The external server S1 with such a configuration is also referred to as an OTA (Over The Air) server. An in-vehicle ECU 3 provided in the vehicle C acquires an update program transmitted from the external server S1 via wireless communication, applies the update program as a program to be executed, and is thus able to update (reprogram) the program to be executed by the ECU.

Hereinafter, the program is described as a program that includes: a program code that contains control syntax that is to be used by an in-vehicle ECU 3 to perform processing; and an external file that contains data to be referred to when the program code is executed. When the update program is transmitted, an external file that contains such a program code and data is transmitted from the external server S1 as, for example, an encrypted archive file.

The vehicle C is provided with the vehicle exterior communication device 1, the in-vehicle update device 2, a display device 5, and a plurality of in-vehicle ECUs 3 for controlling various in-vehicle devices. The vehicle exterior communication device 1 and the in-vehicle update device 2 are connected via a harness such as a serial cable harness so as to be able to communicate with each other. The in-vehicle update device 2 and the in-vehicle ECU 3 are connected via a vehicle interior LAN 4 that conforms to a communication protocol such as a CAN (Control Area Network (registered trademark)) or Ethernet (registered trademark) so as to be able to communicate with each other. The vehicle interior LAN 4 is constituted by communication lines (CAN buses or Ethernet cables) that conform to the CAN or Ethernet, and the vehicle interior LAN 4 is segmented by the communication lines.

The vehicle exterior communication device 1 includes a vehicle exterior communication unit 11, and an input/output I/F (interface) 12 for communicating with the in-vehicle update device 2. The vehicle exterior communication unit 11 is a communication device for performing wireless communication using a mobile communication protocol such as 3G, LTE, 4G, or Wi-Fi, and transmits data to, and receives data from, the external server S1 via an antenna 13 connected to the vehicle exterior communication unit 11. Communication between the vehicle exterior communication device 1 and the external server is performed via an external network such as a public network or the Internet, for example.

The input/output I/F 12 is a communication interface for performing, for example, serial communication with the in-vehicle update device 2. The vehicle exterior communication device 1 and the in-vehicle update device 2 communicate with each other via the input/output I/F 12 and a harness such as a serial cable harness connected to the input/output I/F 12. In the present embodiment, the vehicle exterior communication device 1 and the in-vehicle update device 2 are separate devices and are connected via the input/output I/F 12 so as to be able to communicate with each other. However, the present disclosure is not limited to such a configuration. The vehicle exterior communication device 1 may be built into the in-vehicle update device 2 as one constitutional part of the in-vehicle update device 2.

The in-vehicle update device 2 includes a control unit 20, the storage unit 21, and vehicle interior communication units 23. The in-vehicle update device 2 is configured to acquire an update program that the vehicle exterior communication device 1 has received from the external server S1 via wireless communication, from the vehicle exterior communication device 1, and transmit the update program to a predetermined in-vehicle ECU 3 (an update-target in-vehicle ECU 3) via the vehicle interior LAN 4. The in-vehicle update device 2 is a gateway (a relay device) that generally controls segments of a plurality of systems such as an in-vehicle ECU 3 of a control system, an in-vehicle ECU 3 of a safety system, and an in-vehicle ECU 3 of a body system, for example, and relays communication between the in-vehicle ECUs 3 of these segments. Alternatively, the in-vehicle update device 2 may be configured as one functional unit of the body ECU that controls the entirety of the vehicle C.

The control unit 20 is realized by a CPU (Central Processing Unit), a MPU (Micro Processing Unit), or the like, and is configured to perform various kinds of control processing, computation processing, and the like by reading out and executing a control program and data stored in the storage unit 21 in advance.

The storage unit 21 is realized by a volatile memory device such as a RAM (Random Access Memory) or a nonvolatile memory device such as a ROM (Read Only Memory), an EEPROM (Electrically Erasable Programmable ROM), or a flash memory, and a control program and data to be referred to at the time of processing are stored therein in advance. The control program stored in the storage unit 21 may be a control program read out from a recording medium 22 that can be read by the in-vehicle update device 2, and stored in the storage unit 21. Also, the control program may be a control program downloaded from an external computer (not shown) connected to a communication network (not shown), and stored in the storage unit 21. Furthermore, configuration information (vehicle configuration information) regarding all of the in-vehicle ECUs 3 provided in the vehicle C, an update program acquired from the external server S1, and information (update processing log data) regarding the progress of transmission of the update program to the in-vehicle ECU 3 are stored in the storage unit 21. Moreover, communication log data transmitted via the vehicle interior LAN, and saved data that contains all of the data (freeze frame data) that is transmitted via the vehicle interior LAN when an abnormality occurs in the vehicle are stored in the storage unit 21.

Configuration information (vehicle configuration information) regarding each in-vehicle ECU 3 that is stored in the storage unit 21 contains, for example, the production number (serial number) of this in-vehicle ECU 3, the ECU unit number (model number), the software unit number, the current version of the program, the old version of the program, the number of operating banks, the operating banks, a MAC (Media Access Control) address, an IP address, the date of the previous update, the reprogramming status, and the VIN (vehicle identification number). Also, if an in-vehicle ECU 3 is connected using the CAN, the configuration information of the in-vehicle ECU 3 may contain a CAN-ID to be used (contained) when the in-vehicle ECU 3 transmits a message. Such vehicle configuration information is managed in association with an ECU-ID such as a sequential number that is set so that every in-vehicle ECU 3 has a unique number, and is stored as, for example, table form data in the storage unit 21. At a predetermined timing such as when an IG switch for activating or deactivating the vehicle is turned on or off, the control unit 20 constantly acquires, from all of the in-vehicle ECUs 3 or a predetermined in-vehicle ECU 3 provided in the vehicle C, configuration information of the in-vehicle ECU(s) 3, and stores the acquired configuration information in the storage unit 21. Alternatively, the vehicle configuration information may contain information regarding the storage capacity and a current free space of the storage unit 31 of each in-vehicle ECU 3. The control unit 20 can recognize the hardware configuration of an in-vehicle ECU 3, and derive a non-operating bank, the storage capacity, and the current free space of the storage unit 31 of this in-vehicle ECU 3, based on the production number (serial number) of the in-vehicle ECU 3, the ECU unit number (model number), the number of operating banks, the operating banks, the storage capacity, and the current free space contained in the vehicle configuration information stored in the storage unit 21.

The control unit 20 corresponds to an update program acquisition unit that acquires an update program transmitted from the external server S1 via the vehicle exterior communication device 1, by executing the control program stored in the storage unit 21. The control unit 20 corresponds to a total data volume derivation unit that derives the total data volume of the update program that is acquired from the external server S1 based on update information (campaign data) transmitted from the external server S1, by executing the control program stored in the storage unit 21. The control unit 20 corresponds to a saved data capacity derivation unit that derives the volume of saved data (savable data volume) that can be transmitted to the external server S1 or a non-update target in-vehicle ECU 3, by executing the control program stored in the storage unit 21. The control unit 20 corresponds to a determination unit that determines, by executing the control program stored in the storage unit 21, whether or not the saved data needs to be transmitted to the external server S1 or the non-update target in-vehicle ECU 3, based on the derived total data volume of the update program and the current free space of the storage unit 21 of the control unit 20. The control unit 20 corresponds to a saved data transmission unit that transmits the saved data to the external server S1 or the non-update target in-vehicle ECU 3 based on the result of the determination performed by the determination unit, by executing the control program stored in the storage unit 21. The control unit 20 corresponds to an update program transmission unit that transmits the update program acquired from the external server S1 to the update target in-vehicle ECU 3, by executing the control program stored in the storage unit 21.

The vehicle interior communication units 23 are input/output interfaces that employ a communication protocol such as a CAN (Control Area Network) or Ethernet (registered trademark), and the control unit 20 communicates with the in-vehicle ECUs 3 that are connected to the vehicle interior LAN 4 or another in-vehicle device such as a relay device via the vehicle interior communication units 23. A plurality of (three in the drawing) vehicle interior communication units 23 are provided, and communication lines (CAN buses or Ethernet cables) that constitute the vehicle interior LAN 4 are respectively connected to the vehicle interior communication units 23. By providing a plurality of vehicle interior communication units 23 in this way, the vehicle interior LAN 4 is divided into a plurality of segments, and the in-vehicle ECUs are connected to the respective segments according to the function (the control system function, the safety system function, or the body system function) of the in-vehicle ECU. Alternatively, if the vehicle C has an automated driving function (a recognition system function, a determination system function, or an operation system function), the in-vehicle ECUs 3 may be connected to the respective segments according to the function (the recognition system function, the determination system function, and the operation system function) of the in-vehicle ECU 3.

Each in-vehicle ECU 3 includes a control unit 30, a storage unit 31, and a vehicle interior communication unit 32. The storage unit 31 is realized by a volatile memory device such as a RAM (Random Access Memory) or a nonvolatile memory device such as a ROM (Read Only Memory), an EEPROM (Electrically Erasable Programmable ROM), or a flash memory, and a program or data for the in-vehicle ECU 3 is stored therein. This program or data is the update target that is to be updated with the update program transmitted from the in-vehicle update device 2.

The storage unit 31 includes a first storage area (a first bank) 311 and a second storage area (a second bank) 312. The storage unit 31 stores two programs, namely a program (a current version) that is currently executed (applied) by the in-vehicle ECU 3 and a program (an old version) that was applied before the current version. The current version of the program and the old version of the program are separately stored in the first storage area 311 and the second storage area 312. That is to say, if the current version of the program is stored in the first storage area 311, the old version of the program is stored in the second storage area 312. If the old version of the program is stored in the first storage area 311, the current version of the program is stored in the second storage area 312. In this way, by storing two programs, i.e., the current version and the old version, in the form of a so-called “dual-bank storage”, even if a problem occurs in the current version of the program, the control unit 30 reads and executes (switches to) the old version of the program previously applied and ran normally. Thus, it is possible to enhance the reliability of the in-vehicle ECU 3 (in-vehicle ECU 3 in the form of a dual-bank storage).

The storage unit 31 stores information regarding the versions of the two programs, namely, the current version and the old version, and information regarding the area (the operating bank) in which the currently executed (applied) program is stored. That is to say, if the program stored in the first storage area (the first bank) 311 is currently executed, the storage unit 31 stores information indicating that the operating bank is the first storage area (the first bank) 311. If the program stored in the second storage area (the second bank) 312 is currently executed, the storage unit 31 stores information indicating that the operating bank is the second storage area (the second bank) 312. The storage unit 31 stores information regarding the configuration of the ECU thereof, information regarding the progress of reception of an update program from the in-vehicle update device 2, including version information regarding the version of the program (the current version and the old version) and information regarding the operating bank.

The control unit 30 is realized by a CPU (Central Processing Unit), a MPU (Micro Processing Unit), or the like, and performs control processing and the like by reading out and executing a program and data stored in the storage unit 31 (the operating bank) so that in-vehicle devices, including the in-vehicle ECU 3, or actuators or the like are controlled.

The control unit 30 of the in-vehicle ECU 3 receives an update program transmitted from the in-vehicle update device 2, via the vehicle interior communication unit 32, and acquires the update program. Therefore, the control unit 30 of the ECU 3 acquires the update program transmitted from the external server S1, via the vehicle exterior communication device 1 and the in-vehicle update device 2. The control unit 30 stores the acquired update program in the storage area that is not the operating bank (the first storage area 311 or the second storage area 312). That is to say, when the control unit 30 is to acquire the update program transmitted from the in-vehicle update device 2, the control unit 30 deletes the program stored in the storage area that is not the operating bank (non-operating bank), as preparatory processing for the acquisition. Usually, the program stored in the storage area that is not the operating bank is an old version of the program that was executed before the current version of the program, and therefore the old version can be deleted without stopping the function of the in-vehicle ECU 3 of controlling in-vehicle devices. The control unit 30 deletes the old version of the program stored in the storage area (non-operating bank) that is not the operating bank, and stores the update program transmitted from the in-vehicle update device 2 in the non-operating bank.

After having successfully completed the reception of the update program, the control unit 30 of the in-vehicle ECU 3 switches the operating bank, and applies and executes the received update program as the current version of the program. In the case where the reception of the update program is successful and the operating bank is successfully switched, the control unit 30 of the in-vehicle ECU 3 stores information indicating that the update of the program is complete (successfully terminated) in the storage unit 31, and further transmits (makes a notification of) the information to the in-vehicle update device 2. Since the control unit 30 determines that the update of the program is complete (successfully terminated) when the operating bank has been successfully switched, it is possible to secure the accuracy of this determination.

Alternatively, after having successfully completed the reception of the update program and having switched the operating bank, the control unit 30 of the in-vehicle ECU 3 performs self-diagnosis processing based on the function of this in-vehicle ECU 3. A self-diagnosis processing program for performing self-diagnosis processing based on the function of an in-vehicle ECU 3 is stored in advance in the storage unit 31 of this in-vehicle ECU 3. Alternatively, the self-diagnosis processing program may be a program that is included in the update program, and is transmitted together with the update program from the in-vehicle update device 2.

If the result of the self-diagnosis processing performed on the switched update program is normal, the control unit 30 may store information indicating that the update of the program is complete (successfully terminated) in the storage unit 31, and may further transmit (makes a notification of) the information to the in-vehicle update device 2. Since the control unit 30 determines that the update of the program is complete (successfully terminated) if the result of the self-diagnosis processing is normal, it is possible to further improve the accuracy of this determination.

Alternatively, after having successfully completed the reception of the update program and before switching the operating bank, the control unit 30 of the in-vehicle ECU 3 performs self-diagnosis processing on the update program stored in the storage area of the non-operating bank. If the result of the self-diagnosis processing performed on the update program is normal, the control unit 30 stores information indicating that the update of the program is completed (successfully terminated) in the storage unit 31, and further transmits (makes a notification of) the information to the in-vehicle update device 2. Since, after having successfully completed the reception of the update program and before switching the operating bank, that is, before applying the update program, the control unit 30 performs self-diagnosis processing on the update program stored in the storage area of the non-operating bank, the control unit 30 can determine whether or not the update is possible using the update program without affecting the operation of the control function of the in-vehicle device that is being currently executed by the in-vehicle ECU 3.

If the switching to the update program fails, or the result of the self-diagnosis processing performed on the update program is abnormal, the control unit 30 of the in-vehicle ECU 3 performs rollback processing, that is, performs switching (rollback) so that the storage area of the non-operating bank in which the previous version (old version) of the program for the update program is stored serves as the storage area of the operating bank, and executes (applies) the previous version of the program. When the switching to the update program fails, or the result of the self-diagnosis processing performed on the update program is abnormal, the control unit 30 of the in-vehicle ECU 3 may store information indicating that the update has failed (unsuccessfully terminated) in the storage unit 31, and may further transmit (makes a notification of) the information to the in-vehicle update device 2.

The previous version of the program for the update program is a program that was executed when the update program was transmitted, and is therefore a program with operation results. Accordingly, even if the update of the update program fails, the control unit 30 performs rollback processing to a program with operation results (switch the operating bank), and executes this program, and thus it is possible to continue the control function of controlling the in-vehicle device.

The control unit 30 of the in-vehicle ECU 3 determines whether or not the update with the update program is successful, based on the switching to the update program (switching of the operating bank) or the result of the self-diagnosis processing, but the present disclosure is not limited thereto. The control unit 30 of the in-vehicle ECU 3 may determine that the update is successful if an abnormality that occurs due to the update program is not detected between when switching to the update program is complete and the update program is executed, and when a predetermined period of time has elapsed, or accumulated operation time of the vehicle C, the number of trips, or the driving distance, or the like is greater than or equal to a predetermined value, for example.

The display device 5 is an HMI (Human Machine Interface) device such as a display of a car navigation system, for example. The display device 5 is connected to an input/output I/F 24 of the in-vehicle update device 2 via a harness such as a serial cable harness so as to be able to communicate with each other. The display device 5 displays data or information output from the control unit 20 of the in-vehicle update device 2 via the input/output I/F 24. The display device 5 and the in-vehicle update device 2 do not necessarily have to be connected via the input/output I/F 24 or the like, and the display device 5 and the in-vehicle update device 2 may be connected via the vehicle interior LAN 4.

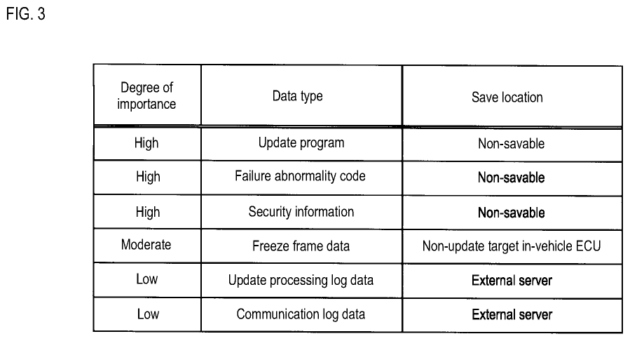

FIG. 3 is a diagram showing an example of an aspect of saved data that is stored in the storage unit 21. FIG. 3 shows, in a tabular form (table form), examples of various types of data for which a degree of importance, a data type, and a save location (destination) serving as a destination are set and that is to be transmitted to the external server S1 or an in-vehicle ECU 3 as saved data.

As described above, the storage unit 21 of the in-vehicle update device 2 stores, in addition to the control program or data for controlling the in-vehicle update device 2, in-vehicle configuration information acquired from each of the in-vehicle ECUs 3, and update programs regarding update processing for the in-vehicle ECUs 3. The storage unit 21 of the in-vehicle update device 2 further stores various types of log data regarding the operation state of the vehicle C, that is, information indicating the operation state, as time-series data.

Saved data to be transmitted by the in-vehicle update device 2 to the external server S1 or a non-update target in-vehicle ECU 3 is mainly constituted by various types of log data regarding the operation state of the vehicle C. As shown in FIG. 3, various types of log data, which is dealt with as saved data, includes freeze frame data, update processing log data, and communication log data, for example.

When controlling the relay of communication to the in-vehicle ECUs 3, the control unit 20 of the in-vehicle update device 2 receives data transmitted from these in-vehicle ECUs 3, extracts failure abnormality codes contained in the data, and stores the failure abnormality codes in the storage unit 21. The control unit 20 of the in-vehicle update device 2 fulfills, for example, a self-diagnosis function (OBD/In-vehicle diagnostics) for the in-vehicle update device 2 by executing the control program, and stores the failure abnormality codes output based on the diagnostic result of the self-diagnosis as log data regarding the operation state of the in-vehicle update device 2, in the storage unit 21. When storing these failure abnormality codes, the control unit 20 of the in-vehicle update device 2 acquires data such as a CAN message or an Ethernet (registered trademark) frame that is transferred through the vehicle interior LAN 4 at this moment, and stores the data as freeze frame data in the storage unit 21. The control unit 20 of the in-vehicle update device 2 transmits an update program to an update target in-vehicle ECU 3, and stores the processing history of update processing (reprogramming processing) performed for this in-vehicle ECU 3, as update processing log data, in the storage unit 21. When controlling the relay of communication to the in-vehicle ECUs 3, the control unit 20 of the in-vehicle update device 2 stores communication log data such as an amount of data to be transmitted to and received from each segment per unit of time, an amount of traffic, and the number of transmission and reception for each type of message, in the storage unit 21.

The degree of importance with respect to the use of the in-vehicle update device 2 or the travel of the vehicle C, or the like is set for saved data, which is stored in the storage unit 21 of the in-vehicle update device 2 and is constituted by various types of log data and the like, and a destination (save location) is determined based on this degree of importance. Saved data having a low degree of importance is transmitted to the external server S1, and saved data having a moderate degree of importance is transmitted to a non-update target in-vehicle ECU 3. That is, saved data that is transmitted to the external server S1 has a lower degree of importance for the in-vehicle update device 2 or the vehicle C than a degree of importance of saved data that is transmitted to a non-update target in-vehicle ECU 3. By saving saved data having a relatively-high degree of importance for the in-vehicle update device 2 or the vehicle C within the vehicle C (within the vehicle thereof) in this way, it is possible to reliably store the saved data.

Data that is important for the use of the in-vehicle update device 2, such as a failure abnormality code and security information, for example, may be regarded as non-savable data, and may be forbidden to be transmitted to the external server S1 or a non-update target in-vehicle ECU 3, even if the data is of various types of log data regarding the operation state of the vehicle C.

A description has been given in which saved data is log data, of various types, regarding the operation state of the vehicle C, but the present disclosure is not limited thereto. The control unit 20 of the in-vehicle update device 2 may be configured to transmit any of various types of data stored in the storage unit 21 of the in-vehicle update device 2, serving as the saved data, to a save location (destination device), namely, one of the C and a non-update target in-vehicle ECU 3, based on the degree of importance of the data, and may save the data.

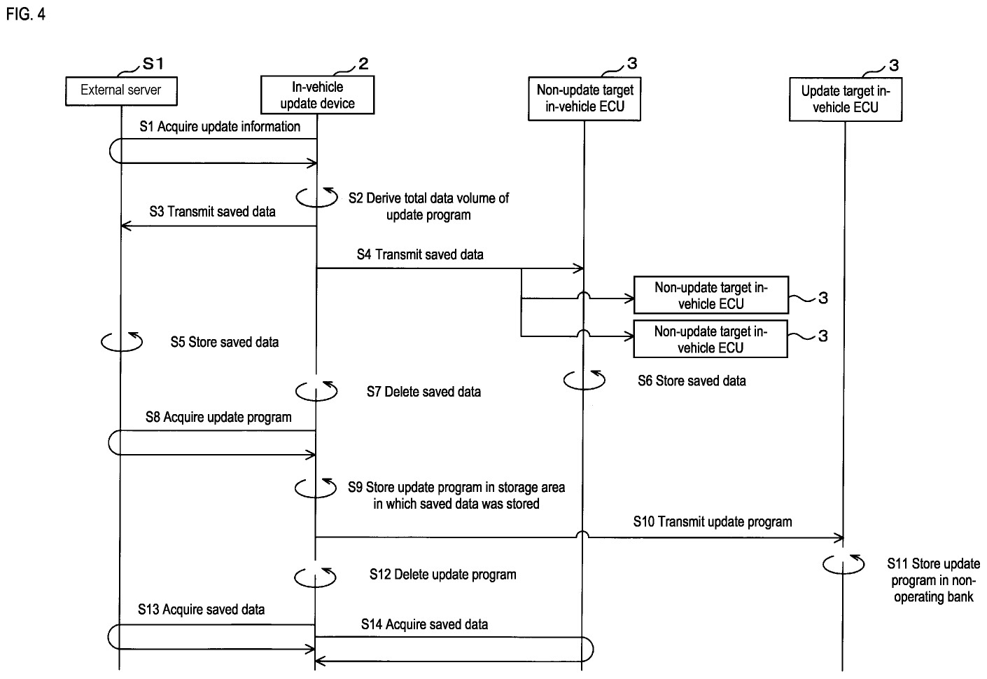

FIG. 4 is a diagram (sequence diagram) showing an example of an aspect of update performed by the in-vehicle update device 2. FIG. 4 illustrates processing in which when acquiring an update program from the external server S1, the in-vehicle update device 2 transmits saved data stored in the storage unit 21 of the in-vehicle update device 2 to the external server S1 or a non-update target in-vehicle ECU 3 and saves this saved data, in a sequence diagram that includes processing performed by the external server S1 and the in-vehicle ECU 3.

The in-vehicle update device 2 acquires update information (campaign information) (step S1). The in-vehicle update device 2 accesses the external server S1, for example, constantly, at fixed intervals, or when an IG switch for activating the vehicle C is turned on, and checks whether or not there is update information regarding whether or not an in-vehicle ECU 3 installed in the vehicle needs to be updated. If there is update information, the in-vehicle update device 2 acquires this update information from the external server S1. The update information includes, for example, information regarding the model number of an update target in-vehicle ECU 3, the version of the program, and the file name and size of an archive file that includes this program. The update information may include information regarding the maximum volume of saved data that can be transmitted from the in-vehicle update device 2 to the external server S1. The maximum volume of saved data means the size (quota) of the storage area of the storage unit S11 of the external server S1 that the in-vehicle update device 2 can use as a storage location for the saved data.

The in-vehicle update device 2 derives the total data volume of the update program (step S2). The in-vehicle update device 2 derives the total data volume of the update program based on the acquired update information. If the update program is constituted by a plurality of files, the total data volume of the update program is, of course, the sum of the sizes (data volumes) of the plurality of files.

The in-vehicle update device 2 transmits saved data to the external server S1 (step S3). The in-vehicle update device 2 specifies the saved data having a degree of importance such that it can be transmitted to and saved in the external server S1 with reference to the storage unit 21, and transmits the specified saved data to the external server S1. The specification may also be made with reference to a table indicating the data types of saved data as shown in FIG. 3.

The in-vehicle update device 2 transmits saved data to a non-update target in-vehicle ECU 3 (step S4). The in-vehicle update device 2 specifies the non-update target in-vehicle ECU 3 that is to serve as the destination of the saved data, with reference to in-vehicle configuration information stored in the storage unit 21. For example, the in-vehicle update device 2 may be configured to extract in-vehicle ECUs 3 in the form of a dual-bank storage, and specify the in-vehicle ECU 3 that does not need to perform rollback processing and can delete the previous version of the program stored in the non-operating bank, as the non-update target in-vehicle ECU 3 that is to serve as a destination for the saved data. The in-vehicle update device 2 is not limited to specifying a single non-update target in-vehicle ECU 3 as the destination of saved data, and may specify a plurality of non-update target in-vehicle ECUs 3 (group of non-update target in-vehicle ECUs 3).

If the in-vehicle update device 2 specifies a plurality of in-vehicle ECUs 3 as a group of non-update target in-vehicle ECUs 3, preferably, the plurality of non-update target in-vehicle ECUs 3 are respectively connected to different vehicle interior communication units 23. By connecting the non-update target in-vehicle ECUs 3 serving as the destination of the saved data to different vehicle interior communication units 23, the in-vehicle ECUs 3 are respectively connected to separate segments. Accordingly, even if the in-vehicle update device 2 performs processing for transmitting the saved data to the in-vehicle ECUs 3 connected to different vehicle interior communication units 23 in parallel, it is possible to suppress an increase in the traffic of the segments to which the in-vehicle ECUs 3 are respectively connected, and efficiently transmit the saved data to the in-vehicle ECUs 3.

The in-vehicle update device 2 specifies the saved data having a degree of importance such that it can be transmitted to and saved in a non-update target in-vehicle ECU 3 with reference to the storage unit 21, and transmits the specified saved data to the non-update target in-vehicle ECU 3. As described above, the saved data that can be transmitted to and saved in the non-update target in-vehicle ECU 3 is data that has a higher degree of importance for the in-vehicle update device 2 or the vehicle C than the degree of importance of the saved data that can be transmitted to and saved in the external server S1.

The transmission to the external server S1 and the transmission to the non-update target in-vehicle ECU 3 are not limited to being performed sequentially in an order, and may be such that the in-vehicle update device 2 transmits the respective pieces of saved data to the external server S1 and the non-update target in-vehicle ECU 3 in parallel.

The external server S1 stores the saved data in the storage unit S11 of the external server S1 (step S5). The non-update target in-vehicle ECU 3 stores the saved data in the storage unit 31 (storage area of the non-operating bank) of the non-update target in-vehicle ECU 3 (step S6). As a result of the external server S1 and the non-update target in-vehicle ECU 3 storing the saved data transmitted from the in-vehicle update device 2, the saved data is completely saved. The external server S1 and the non-update target in-vehicle ECU 3 that have completely stored all of the saved data transmitted from the in-vehicle update device 2 may output (transmit or makes a notification of) information indicating that the transmitted saved data is completely saved, to the in-vehicle update device 2.

The in-vehicle update device 2 deletes the saved data transmitted to the external server S1 or the non-update target in-vehicle ECU 3 (step S7). The in-vehicle update device 2 that has completed the transmission of the saved data to the external server S1, or to the external server S1 and the non-update target in-vehicle ECU 3 deletes the saved data for which transmission is complete. Deleting the saved data can increase the free space of the storage unit 21 of the in-vehicle update device 2.

The in-vehicle update device 2 acquires the update program (step S8), and stores the acquired update program in the storage area in which the transmitted saved data was stored (step S9). The in-vehicle update device 2 stores the update program acquired (received) from the external server S1 in the free area (storage area) secured by deleting the saved data, or in the free area secured by deleting the saved data and the free area existing before deleting the saved data. The storage area in which the update program is stored is defined as the free area secured by deleting the saved data, but the present disclosure is not limited thereto. The in-vehicle update device 2 may also overwrite and store the update program in the storage area in which the saved data is stored, without deleting the saved data.

The in-vehicle update device 2 transmits the update program to the update target in-vehicle ECU 3 (step S10). The in-vehicle update device 2 may transmit the update program stored in the storage unit 21 of the in-vehicle update device 2 to the update target in-vehicle ECU 3, and may then output an update processing start signal for starting update processing, to the update target in-vehicle ECU 3.

The update target in-vehicle ECU 3 stores the update program in the non-operating bank of the storage unit 31 (step S11), and switches to the update program at a predetermined timing. A configuration is also possible in which, when the switching to the update program is executed and the update processing (reprogramming processing) is complete, the update target in-vehicle ECU 3 outputs (transmits or makes a notification of) information regarding the completion of the update processing to the in-vehicle update device 2.

The in-vehicle update device 2 deletes the update program stored in the storage unit 21 (step S12). After having completed the transmission or having acquired (received) information regarding the completion of the update processing from the update target in-vehicle ECU 3, the in-vehicle update device 2 deletes the update program.

The in-vehicle update device 2 acquires the saved data from the external server S1 and the update target in-vehicle ECU 3 (steps S13 and 14). The in-vehicle update device 2 stores the saved data acquired from the external server S1 serving as a saving destination, or from the external server S1 and the non-update target in-vehicle ECU 3 serving as saving destinations, in the free area of the storage unit 21 secured by deleting the update program.

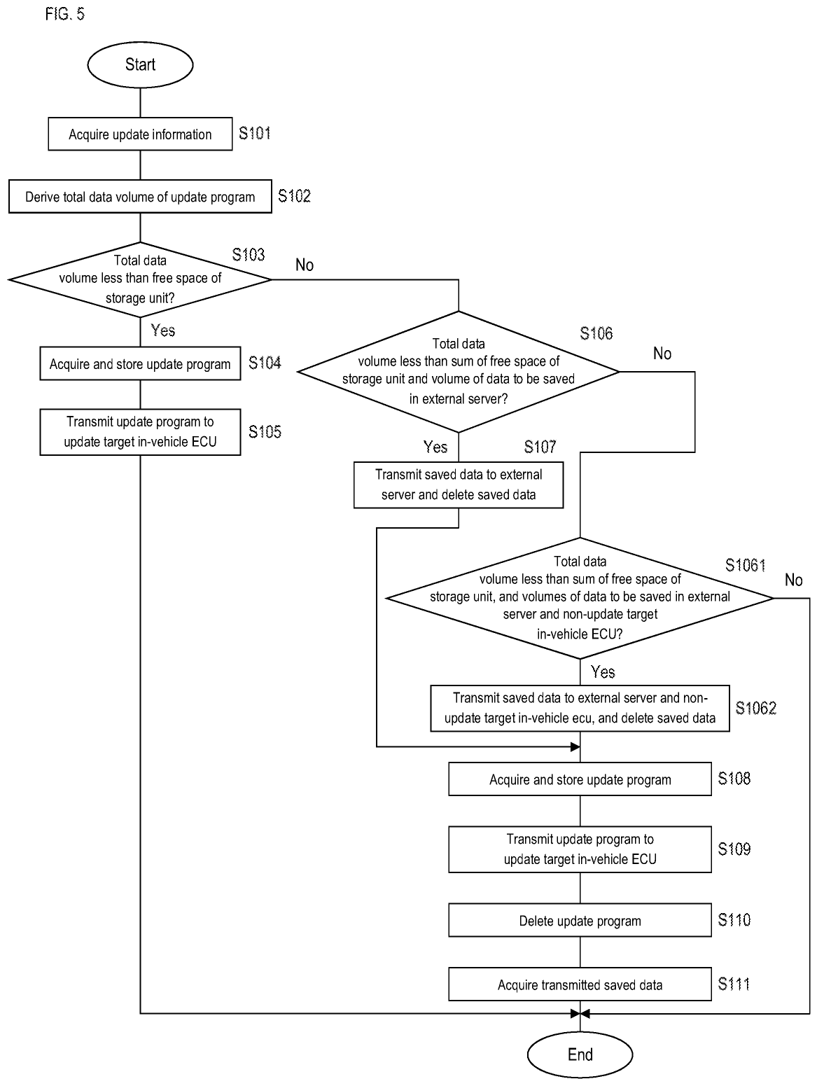

FIG. 5 is a flowchart showing an example of processing performed by the control unit 20 of the in-vehicle update device 2. If the amount of charge of a charging device (not shown) of the in-vehicle update device 2 is greater than or equal to a predetermined value regardless of whether the vehicle C is in an activated state (in which the IG switch is on) or in a deactivated state (in which the IG switch is off), the control unit 20 of the in-vehicle update device 2 communicates with the program providing device via the vehicle exterior communication device 1 constantly or at fixed intervals, and performs the following processing.

The control unit 20 of the in-vehicle update device 2 acquires the update information (step S101). The control unit 20 communicates with the external server S1 via the vehicle exterior communication device 1 at fixed intervals, and checks whether or not there is update information. If there is update information, the control unit 20 acquires the update information from the external server S1.

The control unit 20 of the in-vehicle update device 2 derives the total data volume of the update program (step S102). For example, the control unit 20 extracts the total data volume of the update program that is contained in the acquired update information, and derives the total data volume.

The control unit 20 of the in-vehicle update device 2 determines whether or not the total data volume is less than the free space of the storage unit 21 (step S103). The control unit 20 checks the free space of the storage unit 21 of the control unit 20, compares the derived total data volume with the free space, and determines whether or not the total data volume is less than the free space of the storage unit 21.

If the total data volume is less than the free space of the storage unit 21 (YES in step S103), the control unit 20 of the in-vehicle update device 2 acquires the update program, and stores the acquired update program (step S104). When the total data volume of the update program to be acquired is less than the free space of the storage unit 21, the control unit 20 can store (save) this update program without deleting saved data.

The control unit 20 of the in-vehicle update device 2 transmits the update program to an update target in-vehicle ECU 3 (step S105). The update target in-vehicle ECU 3 that has acquired (received) the update program applies this update program at a predetermined timing, and executes update processing.

If the total data volume is not less than the free space of the storage unit 21 (NO in step S103), that is, if the total data volume is greater than the free space of the storage unit 21, the control unit 20 of the in-vehicle update device 2 determines whether or not the total data volume is less than the sum of the free space of the storage unit 21 and the volume of data that can be saved in the external server S1 (step S106). The control unit 20 extracts, for example, the available capacity of the storage area of the external server S1 that is contained in the acquired update information (maximum volume of saved data that can be transmitted to the external server S1). Alternatively, the control unit 20 may be configured to communicate with the external server S1, and acquire the available capacity of the storage area of the external server S1. The control unit 20 uses the available capacity of the storage area of the external server S1 as the volume of data that can be saved in the external server S1 to calculate the sum of the free space of the storage unit 21 and the volume of data that can be saved in the external server S1, and compares the calculated sum with the total data volume.

If the total data volume is less than the sum of the free space of the storage unit 21 and the volume of data that can be saved in the external server S1 (YES in step S106), the control unit 20 of the in-vehicle update device 2 transmits the saved data to the external server S1 and deletes the saved data (step S107). When the total data volume of the update program is less than the sum of the free space of the storage unit 21 and the volume of data that can be saved in the external server S1, it is not necessary to transmit saved data to a non-update target in-vehicle ECU 3. Accordingly, the control unit 20 transmits the saved data to the external server S1, and deletes the saved data for which transmission is complete.

If the total data volume is not less than the sum of the free space of the storage unit 21 and the volume of data that can be saved in the external server S1 (NO in step S106), the control unit 20 of the in-vehicle update device 2 then determines whether or not the total data volume is less than the sum of the free space of the storage unit 21, and the volumes of data to be saved in the external server S1 and a non-update target in-vehicle ECU 3 (step S1061). When the total data volume is not less than the sum of the free space of the storage unit 21 and the volume of data that can be saved in the external server S1, that is, the total data volume is greater than the sum of the free space of the storage unit 21 and the volume of data that can be saved in the external server S1, the storage area for storing all of the data of the update program cannot be secured even by deleting the saved data transmitted to the external server S1. Accordingly, the control unit 20 specifies a non-update target in-vehicle ECU 3 in the form of a dual-bank storage that can be used as the destination of saved data, with reference to the in-vehicle configuration information stored in the storage unit 21, for example. The control unit 20 may specify a single or a plurality of non-update target in-vehicle ECUs 3. By referring to the in-vehicle configuration information or communicating with the specified non-update target in-vehicle ECU(s) 3, the control unit 20 acquires the storage capacity of the non-operating bank of the storage unit 31 of the specified non-update target in-vehicle ECU(s) 3. The control unit 20 calculates the sum of volumes of data to be saved in the non-update target in-vehicle ECUs 3 based on the sum of the acquired storage capacities, and compares it with the total data volume.

If the total data volume is less than the sum of the free space of the storage unit 21, and the volumes of data to be saved in the external server S1 and the non-update target in-vehicle ECU 3 (YES in step S1061), the control unit 20 of the in-vehicle update device 2 transmits the saved data to the external server S1 and the non-update target in-vehicle ECU 3, and deletes the saved data (step S1062). When the total data volume of the update program is less than the sum of the free space of the storage unit 21, and the volumes of data to be saved in the external server S1 and the non-update target in-vehicle ECU 3, it is possible to secure the storage area for storing all of the data of the update program, by saving (transmitting and deleting) the saved data in the external server S1 and the non-update target in-vehicle ECU 3.

If the total data volume is not less than the sum of the free space of the storage unit 21, and the volumes of data to be saved in the external server S1 and the non-update target in-vehicle ECU 3 (NO in step S1061), the control unit 20 of the in-vehicle update device 2 ends (stops) the series of processing of acquiring the update program and transmitting the update program to the update target in-vehicle ECU 3. When the total data volume of the update program is not less than the sum of the free space of the storage unit 21, and the volumes of data to be saved in the external server S1 and the non-update target in-vehicle ECU 3, that is, the total data volume is greater than this sum, it is impossible to secure the storage area for storing all of the data of the update program, even using the storage area in which the saved data is stored. Accordingly, the control unit 20 stops the series of processing of acquiring the update program and transmitting the update program to the update target in-vehicle ECU 3. A configuration is also possible in which the control unit 20 stores information indicating that the series of processing has been stopped, in the storage unit 21, and outputs the information to the external server S1 or the display device 5, or both of them. It is possible to notify an operator of the vehicle C or an administrator of the external server S1 of the information indicating that the series of processing regarding the acquisition of the update program has been stopped.

After the execution of step S107 or S1062, the control unit 20 of the in-vehicle update device 2 acquires and stores the update program, as in the processing in step S104 (step S108). The area of the storage unit 21 in which the update program is to be stored is an area in which the transmitted saved data was stored, or the free area (free area corresponding to the free space in step S103) that was there before saved data was transmitted and the area in which the transmitted saved data was stored. That is to say, the control unit 20 stores at least part or the entirety of the update program in the area in which the transmitted saved data was stored.

The control unit 20 of the in-vehicle update device 2 transmits the update program to the update target in-vehicle ECU 3, as in the processing in step S105 (step S109).

The control unit 20 of the in-vehicle update device 2 deletes the update program (step S110). The control unit 20 of the in-vehicle update device 2 acquires the transmitted saved data (step S111). The control unit 20 can store, in the free area of the storage unit 21 secured by deleting the update program, the saved data transmitted to (saved in) the external server S1, or the saved data transmitted to (saved in) the external server S1 and the non-update target in-vehicle ECU 3.

After the execution of step S105 or S111, the control unit 20 of the in-vehicle update device 2 ends the processing of this flowchart. Alternatively, the control unit 20 may be configured to perform, after the execution of the processing in step S105 or S111, loop processing to execute the processing in step S101 again.

The control unit 20 of the in-vehicle update device 2 may also be configured to store the determination results regarding the determination (in steps S103, S106, and S1061) in the processing of this flowchart, in the storage unit 21, output the determination results to the display device 5 or the external server S1, and notify the operator of the vehicle C or the administrator of the external server S1 of the information.

In the present embodiment, the description has been given assuming that the control unit 20 of the in-vehicle update device 2 performs the series of processing, but the present disclosure is not limited thereto. The control unit 20 of the in-vehicle update device 2 may be configured to perform inter-process communication or redirection processing with a device other than the in-vehicle update device 2, such as, for example, an in-vehicle ECU 3 or the external server S1, and cooperate with the device so as to perform the series of processing. Alternatively, the control unit 20 of the in-vehicle update device 2 may also be configured to cooperate with a hardware processing unit constituted by a circuit such as an FPGA or ASIC that is included in the in-vehicle update device 2, so as to perform the series of processing.

When acquiring an update program from the external server Si, the in-vehicle update device 2 can transmit saved data stored in the storage unit 21 to the external server Si or a non-update target in-vehicle ECU 3 to save the saved data, and thus can store the update program, even if the capacity of the free area of the storage unit 21 is less than the total data volume of the update program. Accordingly, it is possible to suppress an increase in the storage capacity of the storage unit 21 included in the in-vehicle update device 2, and reduce the cost of the components constituting the storage unit 21.

When transmitting saved data to the external server S1 or the non-update target in-vehicle ECU 3 and saving it, the in-vehicle update device 2 determines the destination according to the degree of importance of the saved data. Since the degree of importance of saved data to be transmitted to the external server S1 is lower than the degree of importance of saved data to be transmitted to the non-update target in-vehicle ECU 3, saved data having a relatively high degree of importance will be transmitted to the non-update target in-vehicle ECU 3 located within the vehicle C, and it is thus possible to realize reliable saving.

Since saved data having a relatively-low priority is first transmitted to the external server S1 to secure the free space of the storage unit 21 of the in-vehicle update device 2, it is possible to suppress such a situation that saved data having a relatively-high degree of importance is needlessly saved.

The in-vehicle update device 2 specifies a plurality of non-update target in-vehicle ECUs 3 as destinations of saved data, and the plurality of non-update target in-vehicle ECUs 3 are respectively connected to different vehicle interior communication units 23, and thus are connected to different segments. Accordingly, even if the in-vehicle update device 2 transmits saved data to the plurality of non-update target in-vehicle ECUs 3 at the same time, that is, if the in-vehicle update device 2 performs transmission processing on these in-vehicle ECUs 3 in parallel, it is possible to suppress an increase in the traffic of a specific segment, and perform the transmission processing in a short time period. By performing the transmission processing on the respective in-vehicle ECUs 3 connected to different vehicle interior communication units 23, it is possible to use the sum of the bandwidths (transmission speeds) determined for the communication units and the segments, as the actual bandwidth for use in the transmission from the in-vehicle update device 2 to each in-vehicle ECU 3.

### Second Embodiment

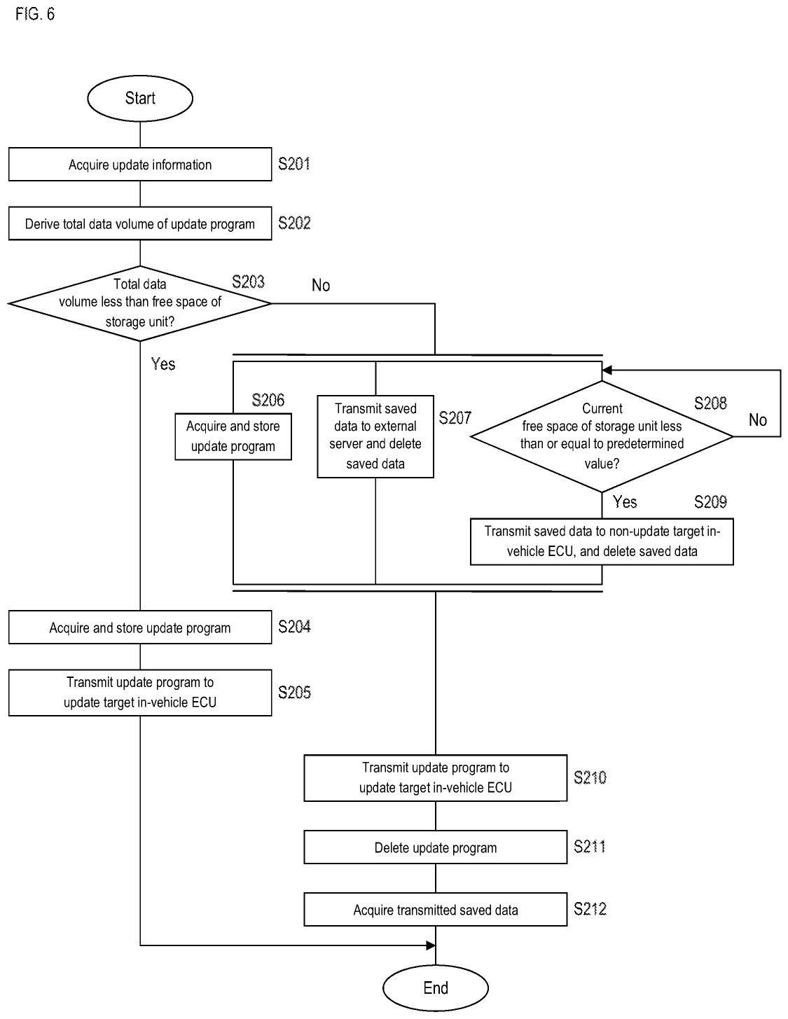

FIG. 6 is a flowchart showing an example of processing performed by a control unit 20 of an in-vehicle update device 2 according to a second embodiment. The control unit 20 of the in-vehicle update device 2 of the second embodiment differs from that of the first embodiment in that the control unit 20 transmits saved data to the external server S1 while acquiring an update program from the external server S1, and if the current free space of the storage unit 21 is reduced to a value less than or equal to a predetermined value, the control unit 20 transmits saved data other than the saved data that is being transmitted to the external server S1, to a non-update target in-vehicle control device.

If the amount of charge of a charging device (not shown) of the in-vehicle update device 2 is greater than or equal to a predetermined value regardless of whether the vehicle C is in the activated state (in which the IG switch is on) or in the deactivated state (in which the IG switch is off), the control unit 20 of the in-vehicle update device 2 in the second embodiment, similar to the control unit 20 of the in-vehicle update device 2 in the first embodiment, communicates with a program providing device via the vehicle exterior communication device 1 constantly or at fixed intervals, and performs the following processing.

The control unit 20 of the in-vehicle update device 2 performs the processing in steps S201, S202, and S203, as in the processing in the first embodiment (steps S101, S102, and S103).

If the total data volume is less than the free space of the storage unit 21 (YES in step S203), the control unit 20 of the in-vehicle update device 2 acquires and stores the update program (step S204), and transmits the acquired update program to an update target in-vehicle ECU 3 (step S205), as in the processing in the first embodiment (steps S104 and S105).

If the total data volume is not less than the free space of the storage unit 21 (NO in step S203), the control unit 20 of the in-vehicle update device 2 acquires the update program, and stores the acquired update program (step S206). The control unit 20 executes the processing in step S206 in the same manner as in the processing in the first embodiment (step S108). Furthermore, the control unit 20 of the in-vehicle update device 2 transmits saved data to the server and deletes the saved data (step S207). The control unit 20 executes the processing in step S207 in the same manner as in the processing in the first embodiment (step S107).

Furthermore, the control unit 20 of the in-vehicle update device 2 determines whether or not the current free space of the storage unit 21 during the acquisition of the update program is less than or equal to a predetermined value (step S208). If the total data volume is not less than the free space of the storage unit 21, that is, the total data volume is greater than the free space of the storage unit 21, the control unit 20 of the in-vehicle update device 2 executes the processing in steps S206, S207, and S208 in parallel.

When performing the processing in steps S206, S207, and S208 in parallel, the control unit 20 may generate, for example, two sub processes from a main process, and perform inter-process communication in these three processes, so as to achieve synchronization between the pieces of processing. If the control unit 20 is a multi-CPU or multi-core that is constituted by a plurality of CPUs or cores, the control unit 20 may execute the three processes using the separate CPU or cores.

The acquisition of the update program from the external server S1, that is, the transmission (transfer, download) of the update program from the external server S1 is performed by terms of blocks into which a file of the update program is divided by a predetermined size. Accordingly, after the start of the processing for acquiring the update program, the number of acquired blocks increases with time, the sum of the data sizes of the blocks, that is, the amount of data of the update program that is being acquired increases, and the free area of the storage unit 21 decreases.

The saved data that is transmitted to the external server S1 is constituted by a plurality of files generated when individual pieces of log data are stored. The control unit 20 of the in-vehicle update device 2 sequentially transmits the plurality of files constituting the saved data to the external server S1, and sequentially deletes the files for which transmission is complete. Accordingly, after transmission of the saved data to the external server S1 is started, the free area of the storage unit 21 increases with time by sequentially deleting the files for which transmission is complete.

As a result of the control unit 20 of the in-vehicle update device 2 performing parallel processing of acquiring the update program and transmitting the saved data, even when the free area of the storage unit 21 decreases due to the acquisition of the update program, it is possible to secure the storage area for storing the update program by deleting the files of the saved data for which transmission is complete. However, there may be a case where the storage area for storing the update program cannot be secured only by saving the saved data in the external server S1, such as a case where the available capacity of the storage area in the external server S1 is limited, or a case where the total volume of saved data having a relatively-low degree of importance that can be transmitted to the external server S1 is less than the total volume of the update program. Therefore, the control unit 20 of the in-vehicle update device 2 continuously executes processing for checking the current free space of the storage unit 21 of the in-vehicle update device 2, parallel to the processing of acquiring the update program and transmitting the saved data. That is, during the execution of the processing of acquiring the update program and transmitting the saved data, the control unit 20 executes processing for monitoring the free space of the storage unit 21.

The control unit 20 of the in-vehicle update device 2 continuously monitors the free space of the storage unit 21, and if the current free space of the storage unit 21 is not less than or equal to a predetermined value (NO in step S208), the control unit 20 executes the processing in step S208 again, and thus continues the processing for monitoring the free space of the storage unit 21 and the processing for determining whether or not the free space of the storage unit 21 is less than or equal to the predetermined value.

As a result of the control unit 20 of the in-vehicle update device 2 continuously monitoring the free space of the storage unit 21, if it is determined that the current free space of the storage unit 21 is less than or equal to the predetermined value (YES in step S208), the control unit 20 transmits saved data to a non-update target in-vehicle ECU 3, and deletes the saved data for which transmission is complete (step S209), as in the processing in the first embodiment (step S1062). The predetermined value is defined based on, for example, a ratio with respect to the storage capacity of the storage unit 21 of the in-vehicle update device 2, and can be defined as a value that corresponds to 10% of this storage capacity. The predetermined value is stored in the storage unit 21 of the in-vehicle update device 2. Alternatively, the control unit 20 may define the predetermined value as 100 Mbyte for example, and store the value in the storage unit 21.

After the execution of the processing in steps S206, S207, and S209, the control unit 20 of the in-vehicle update device 2 executes the processing in steps S210, S211, and S212 in the same manner as in the processing in the first embodiment (steps S109, S110, and S111). If, in the processing in step S208, the state in which the current free space of the storage unit 21 is not less than or equal to the predetermined value (NO in step S208) continues, the control unit 20 will continue the processing in step S208 (of monitoring and determining the free space of the storage unit 21) (loop processing). In contrast, a configuration is also possible in which the control unit 20 acquires all the data (all the blocks) of the update program, stores it in the storage unit 21, and then discontinue the processing in step S208 (end the sub process of performing the processing in step S208).

After having executed the processing in step S205 or S212, the control unit 20 of the in-vehicle update device 2 ends the processing of this flowchart, as in the first embodiment. Alternatively, after having executed the processing in step S205 or S212, the control unit 20 may perform loop processing to execute the processing in step S201 again.

The control unit 20 of the in-vehicle update device 2 may also be configured to store the determination results regarding the determination (steps S203 and S208) in the processing of this flowchart, in the storage unit 21, output the determination results to the display device 5 or the external server S1, and notify the operator of the vehicle C or the administrator of the external server S1 of the information.

The in-vehicle update device 2 performs processing of transmitting saved data to the external server S1 while acquiring an update program from the external server S1, that is, the in-vehicle update device 2 performs processing of acquiring the update program, and processing of transmitting the saved data to the external server S1 in parallel (parallel processing). Accordingly, there is no need of performing a preparatory operation for acquiring the update program, making it possible to reduce the time required for the series of processing of updating an update target in-vehicle ECU 3.

The in-vehicle update device 2 further performs processing of monitoring the free space of the storage unit 21, in parallel to the processing of acquiring the update program and the processing of transmitting the saved data to the external server S1, and determines whether or not saved data needs to be transmitted to a non-update target in-vehicle ECU 3, based on this free space. Also, if it is determined that saved data needs to be transmitted to a non-update target in-vehicle ECU 3, the in-vehicle update device 2 performs the processing of acquiring the update program, the processing of transmitting the saved data to the external server S1, and the processing of transmitting the saved data to the non-update target in-vehicle ECU 3, in parallel. Accordingly, when an update program is acquired, it is possible to reduce the time required for securing an area for storing the update program.

The present embodiments in the present disclosure are examples in all aspects, and should be construed as non-limiting. The scope of the present disclosure is not limited to the above meanings, but is indicated by the claims, and is intended to include all modifications within the meaning and scope equivalent to the scope of the claims.

1. An in-vehicle update device for acquiring an update program transmitted from an external server located outside a vehicle, and performing processing for updating a program for an in-vehicle control device mounted in the vehicle, the in-vehicle update device comprising:
a storage unit; and
a control unit,
wherein the storage unit is configured to store the update program,
the control unit is configured to control transmission of the update program to an update target in-vehicle control device,
when acquiring the update program from the external server, the control unit transmits saved data stored in the storage unit to the external server, or to a non-update target in-vehicle control device other than the update target in-vehicle control device, based on a data type of the saved data, and
the control unit stores at least part of the update program acquired from the external server in an area of the storage unit in which the transmitted saved data was stored.

2. The in-vehicle update device according to claim 1, wherein the saved data to be transmitted to the external server has a lower degree of importance for the in-vehicle update device or the vehicle than a degree of importance of the saved data to be transmitted to the non-update target in-vehicle control device.

3. The in-vehicle update device according to claim 2, wherein the pieces of saved data are each stored in the storage unit with a data type and a degree of importance associated with each other.

4. The in-vehicle update device according to claim 1, wherein the control unit acquires a total data volume of the update program from the external server before acquiring the update program, and
if a sum of free space of the storage unit and a total data volume of the saved data to be transmitted to the external server is less than the total data volume of the update program, the control unit transmits the saved data other than the saved data to be transmitted to the external server, to the non-update target in-vehicle control device.

5. The in-vehicle update device according to claim 1, wherein the control unit acquires a total data volume of the update program from the external server before acquiring the update program, and
if a sum of free space of the storage unit, a total data volume of the saved data to be transmitted to the external server, and a total data volume of the saved data to be transmitted to the non-update target in-vehicle control device is greater than the total data volume of the update program, the control unit transmits the respective pieces of saved data to the external server and the non-update target in-vehicle control device, based on the data types of the respective pieces of saved data.

6. The in-vehicle update device according to claim 1, wherein, while acquiring the update program from the external server, the control unit transmits the saved data to the external server, and
if free space of the storage unit is reduced to a value less than or equal to a predetermined value while the update program is being acquired, the control unit transmits the saved data other than the saved data to be transmitted to the external server, to the non-update target in-vehicle control device.

7. The in-vehicle update device according to claim 1, wherein the vehicle includes a plurality of the in-vehicle control devices,
the in-vehicle update device includes a plurality of vehicle interior communication units for communicating with the plurality of in-vehicle control devices, and
the control unit transmits the saved data to the non-update target in-vehicle control devices respectively connected to the different vehicle interior communication units, in parallel.

8. An update processing program for causing a computer to execute processing of:
transmitting saved data stored in a storage unit to an external server, or to a non-update target in-vehicle control device other than an update target in-vehicle control device mounted in a vehicle, based on a data type of the saved data;
storing an update program acquired from the external server, in an area of the storage unit in which the transmitted saved data was stored; and
transmitting the stored update program to the update target in-vehicle control device.

9. A program update method comprising the steps of:
transmitting saved data stored in a storage unit to an external server, or to a non-update target in-vehicle control device other than an update target in-vehicle control device mounted in a vehicle, based on a data type of the saved data;
storing an update program acquired from the external server, in an area of the storage unit in which the transmitted saved data was stored; and
transmitting the stored update program to the update target in-vehicle control device.

10. The in-vehicle update device according to claim 2, wherein the control unit acquires a total data volume of the update program from the external server before acquiring the update program, and
if a sum of free space of the storage unit and a total data volume of the saved data to be transmitted to the external server is less than the total data volume of the update program, the control unit transmits the saved data other than the saved data to be transmitted to the external server, to the non-update target in-vehicle control device.

11. The in-vehicle update device according to claim 3, wherein the control unit acquires a total data volume of the update program from the external server before acquiring the update program, and
if a sum of free space of the storage unit and a total data volume of the saved data to be transmitted to the external server is less than the total data volume of the update program, the control unit transmits the saved data other than the saved data to be transmitted to the external server, to the non-update target in-vehicle control device.

12. The in-vehicle update device according to claim 2, wherein the control unit acquires a total data volume of the update program from the external server before acquiring the update program, and
if a sum of free space of the storage unit, a total data volume of the saved data to be transmitted to the external server, and a total data volume of the saved data to be transmitted to the non-update target in-vehicle control device is greater than the total data volume of the update program, the control unit transmits the respective pieces of saved data to the external server and the non-update target in-vehicle control device, based on the data types of the respective pieces of saved data.

13. The in-vehicle update device according to claim 3, wherein the control unit acquires a total data volume of the update program from the external server before acquiring the update program, and
if a sum of free space of the storage unit, a total data volume of the saved data to be transmitted to the external server, and a total data volume of the saved data to be transmitted to the non-update target in-vehicle control device is greater than the total data volume of the update program, the control unit transmits the respective pieces of saved data to the external server and the non-update target in-vehicle control device, based on the data types of the respective pieces of saved data.

14. The in-vehicle update device according to claim 4, wherein the control unit acquires a total data volume of the update program from the external server before acquiring the update program, and
if a sum of free space of the storage unit, a total data volume of the saved data to be transmitted to the external server, and a total data volume of the saved data to be transmitted to the non-update target in-vehicle control device is greater than the total data volume of the update program, the control unit transmits the respective pieces of saved data to the external server and the non-update target in-vehicle control device, based on the data types of the respective pieces of saved data.

15. The in-vehicle update device according to claim 2, wherein, while acquiring the update program from the external server, the control unit transmits the saved data to the external server, and
if free space of the storage unit is reduced to a value less than or equal to a predetermined value while the update program is being acquired, the control unit transmits the saved data other than the saved data to be transmitted to the external server, to the non-update target in-vehicle control device.

16. The in-vehicle update device according to claim 3, wherein, while acquiring the update program from the external server, the control unit transmits the saved data to the external server, and
if free space of the storage unit is reduced to a value less than or equal to a predetermined value while the update program is being acquired, the control unit transmits the saved data other than the saved data to be transmitted to the external server, to the non-update target in-vehicle control device.

17. The in-vehicle update device according to claim 2, wherein the vehicle includes a plurality of the in-vehicle control devices,
the in-vehicle update device includes a plurality of vehicle interior communication units for communicating with the plurality of in-vehicle control devices, and
the control unit transmits the saved data to the non-update target in-vehicle control devices respectively connected to the different vehicle interior communication units, in parallel.

18. The in-vehicle update device according to claim 3, wherein the vehicle includes a plurality of the in-vehicle control devices,
the in-vehicle update device includes a plurality of vehicle interior communication units for communicating with the plurality of in-vehicle control devices, and
the control unit transmits the saved data to the non-update target in-vehicle control devices respectively connected to the different vehicle interior communication units, in parallel.

19. The in-vehicle update device according to claim 4, wherein the vehicle includes a plurality of the in-vehicle control devices,
the in-vehicle update device includes a plurality of vehicle interior communication units for communicating with the plurality of in-vehicle control devices, and
the control unit transmits the saved data to the non-update target in-vehicle control devices respectively connected to the different vehicle interior communication units, in parallel.

20. The in-vehicle update device according to claim 5, wherein the vehicle includes a plurality of the in-vehicle control devices,
the in-vehicle update device includes a plurality of vehicle interior communication units for communicating with the plurality of in-vehicle control devices, and
the control unit transmits the saved data to the non-update target in-vehicle control devices respectively connected to the different vehicle interior communication units, in parallel.
